(19) United States
(12) Patent Application Publication
(10) Pub. No.: US 2017/0204988 A1
(43) Pub. Date: Jul. 20, 2017

(54) Reservoir Check Valve System

(71) Applicants: David Moench, Oroville, CA (US); Angela Moench, Oroville, CA (US)

(72) Inventors: David Moench, Oroville, CA (US); Angela Moench, Oroville, CA (US)

(21) Appl. No.: 15/001,351

(22) Filed: Jan. 20, 2016

(51) Int. Cl. F16K 31/22; F16K 15/04

(52) U.S. Cl. CPC F16K 31/22; F16K 15/04

(57) ABSTRACT

A reservoir check valve system includes a reservoir that contains a fluid. A vent is fluidly coupled to the reservoir and the vent may vent air from the reservoir. The vent includes a check valve. The check valve inhibits a liquid contaminant from passing into the reservoir through the vent. Thus, the check valve inhibits the liquid contaminant from contaminating the fluid. The vent inhibits the fluid from being contaminated and the vent maintains potablity of the fluid.

### BACKGROUND OF THE DISCLOSURE

### Field of the Disclosure

The disclosure relates to valve devices and more particularly pertains to a new valve device for inhibiting a well from being contaminated by a liquid contaminant.

### SUMMARY OF THE DISCLOSURE

An embodiment of the disclosure meets the needs presented above by generally comprising a reservoir that contains a fluid. A vent is fluidly coupled to the reservoir and the vent may vent air from the reservoir. The vent includes a check valve. The check valve inhibits a liquid contaminant from passing into the reservoir through the vent. Thus, the check valve inhibits the liquid contaminant from contaminating the fluid. The vent inhibits the fluid from being contaminated and the vent maintains potablity of the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a reservoir check valve system according to an embodiment of the disclosure.

FIG. 2 is a right side view of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DESCRIPTION OF THE PREFERRED EMBODIMENT

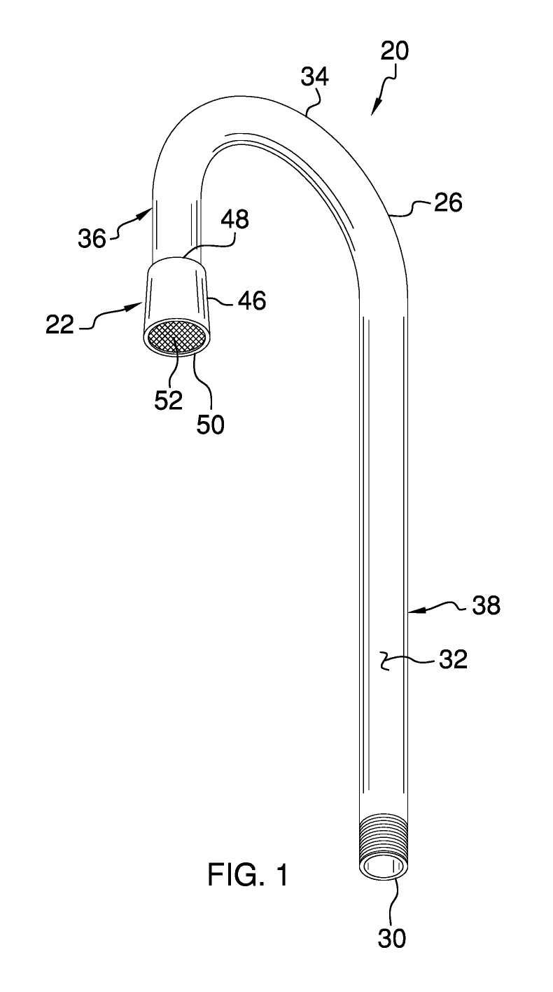

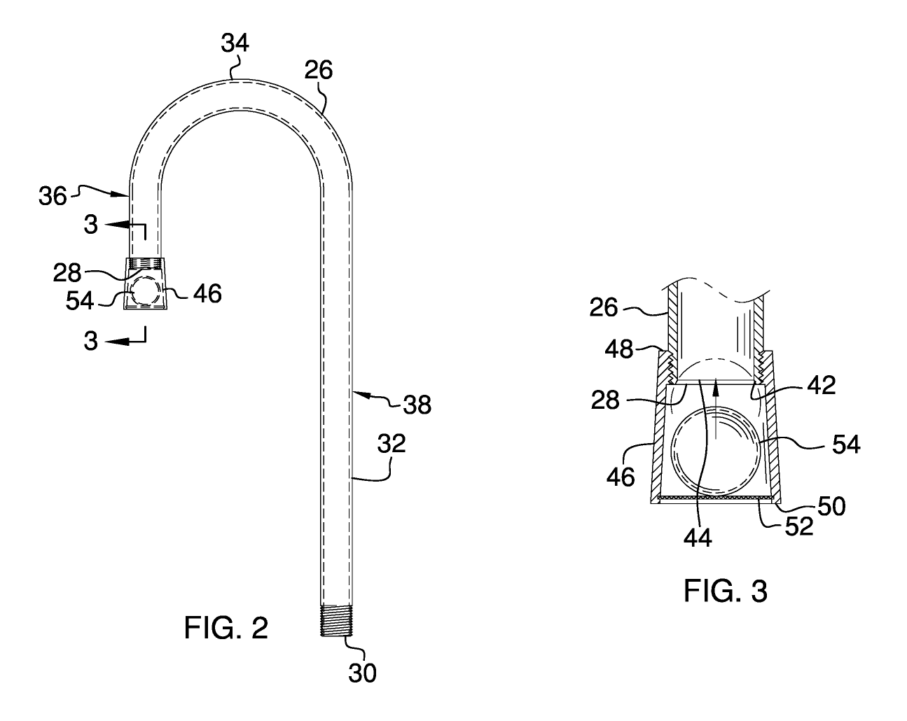

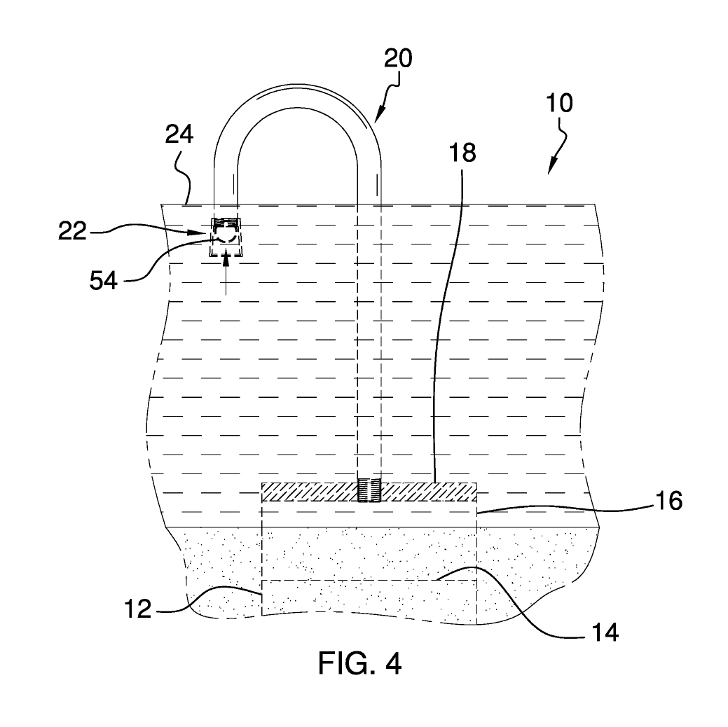

With reference now to the drawings, and in particular to FIGS. 1 through 4 thereof, a new valve device embodying the principles and concepts of an embodiment of the disclosure and generally designated by the reference numeral 10 will be described.

As best illustrated in FIGS. 1 through 4, the reservoir check valve system 10 generally comprises a reservoir 12 that contains fluid 14. The reservoir 12 may comprise a well or the like. The fluid 14 may comprise water or other potable fluid. The reservoir 12 has an outlet 16 and the outlet 16 has a cap 18. The cap 18 may comprise a well seal of any conventional design.

A vent 20 is fluidly coupled to the reservoir 12 and the vent 20 allows air to move into and out of the reservoir 12. The vent 20 includes a check valve 22. The check valve 22 inhibits a liquid contaminant 24 from passing into the reservoir 12 through the vent 20. Thus, the check valve 22 inhibits the liquid contaminant 24 from contaminating the fluid 14.

The vent 20 comprises a pipe 26 that has a first end 28, a second end 30 and an outer surface 32 extending between the first end 28 and the second end 30. The outer surface 32 is threaded adjacent to the second end 30 and the outer surface 32 is threaded adjacent to the first end 28. The pipe 26 has a bend 34 thereon to define a first portion 36 and a second portion 38 of the pipe 26.

The first portion 36 is oriented parallel to the second portion 38. The bend 34 is positioned closer to the first end 28 than the second end 30. Thus, the first portion 36 has a length that is less than a length of the second portion 38. The first portion 36 may have a length ranging between approximately five cm and fifteen cm. The second portion 38 may have a length ranging between approximately ten cm and thirty cm.

The second end 30 threadably engages the cap 18 such that the pipe 26 is in fluid communication with the reservoir 12. The pipe 26 has an inner surface 40. The pipe 26 has a fillet 42 extending between the first end 28 and the inner surface 40. The fillet 42 defines a seat 44 extending around an entire circumference of the first end 28.

A sleeve 46 is provided that has a top end 48 and a bottom end 50. The top end 48 threadably engages the first end 28 such that the sleeve 46 is removably coupled to the pipe 26. A screen 52 is coupled to the sleeve 46. The screen 52 is positioned to completely cover the bottom end 50 and the screen 52 inhibits insects from entering the reservoir 12 through the pipe 26.

A ball 54 is movably positioned within the sleeve 46. The ball 54 is positionable in an open position and a closed position. The ball 54 is spaced from the first end 28 of the pipe 26 when the ball 54 is positioned in the open position. Thus, the ball 54 allows air to pass through the first end 28.

The ball 54 frictionally engages the seat 44 when the ball 54 is in the closed position. The ball 54 forms a fluid impermeable seal with the seat 44 when the ball 54 is in the closed position. The ball 54 is comprised of a buoyant material and ball 54 floats on the liquid contaminant 24 when the liquid contaminant 24 enters the sleeve 46. Thus, the ball 54 is urged into the closed position when the liquid contaminant 24 enters the sleeve 46. The ball 54 inhibits the fluid 14 from being contaminated and the ball 54 maintains potability of the fluid 14. The liquid contaminant 24 may comprise flood waters or other potentially toxic liquid.

In use, the second end 28 of the pipe 26 is threadably coupled to the cap 18. The ball 54 is in the open position and the pipe 26 vents air into and out of the reservoir 12. The ball 54 floats on the liquid contaminant 24 when the liquid contaminant 24 enters the sleeve 46. The liquid contaminant 24 urges the ball 54 to frictionally engage the seat 44. Thus, the ball 54 inhibits the liquid contaminant 24 from entering the reservoir 12. The ball 54 moves into the open position when the liquid contaminant 24 leaves the sleeve 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reservoir check valve system comprising:
a reservoir containing a fluid; and
a vent being fluidly coupled to said reservoir wherein said vent is configured to vent air from said reservoir, said vent including a check valve, said check valve being configured to inhibit a liquid contaminant from passing into said reservoir through said vent, said vent inhibiting said fluid from being contaminated wherein said vent is configured to maintain potablity of said fluid.

2. The assembly according to claim 1, wherein said vent comprises a pipe having a first end, a second end and an outer surface extending between said first end and said second end, said outer surface being threaded adjacent to said second end, said outer surface being threaded adjacent to said first end, said pipe having a bend thereon to define a first portion and a second portion of said pipe, said first portion being oriented parallel to said second portion, said bend being positioned closer to said first end than said second end such that said first portion has a length being less than a length of said second portion.

3. The assembly according to claim 2, wherein:
said reservoir has an outlet, said outlet having a cap; and
said second end threadably engaging said cap such that said pipe is in fluid communication with said reservoir, said pipe having an inner surface, said pipe having a fillet extending between said first end and said inner surface to define a seat extending around an entire circumference of said first end.

4. The assembly according to claim 1, wherein said vent comprises:
a pipe having a first end;
a sleeve having a top end and a bottom end, said top end threadably engaging said first end such that said sleeve is removably coupled to said pipe; and
a screen being coupled to said sleeve, said screen completely covering said bottom end wherein said screen is configured to inhibit insects from entering said reservoir through said pipe.

5. The assembly according to claim 4, further comprising a ball being movably positioned within said sleeve, said ball being positionable in an open position and a closed position.

6. The assembly according to claim 5, wherein said ball is spaced from said first end when said ball is positioned in said open position wherein said ball is configured to allow air to pass through said first end.

7. The assembly according to claim 5, wherein:
said first end has a seat; and
said ball frictionally engages said seat when said ball is in said closed position, said ball forming a fluid impermeable seal with said seat when said ball is in said closed position, said ball being comprised of a buoyant material wherein said ball is configured to float on the liquid contaminant when the liquid contaminant enters said sleeve thereby facilitating said ball to be positioned in said closed position, wherein said ball is configured to inhibit the liquid contaminant from entering said first end, said ball inhibiting said fluid from becoming contaminated wherein said ball is configured to maintain potability of said fluid.

8. A reservoir check valve system comprising:
a reservoir containing a fluid, said reservoir having an outlet, said outlet having a cap; and
a vent being fluidly coupled to said reservoir wherein said vent is configured to vent air from said reservoir, said vent including a check valve, said check valve being configured to inhibit a liquid contaminant from passing into said reservoir through said vent thereby inhibiting the liquid contaminant from contaminating said fluid, said vent comprising:
a pipe having a first end, a second end and an outer surface extending between said first end and said second end, said outer surface being threaded adjacent to said second end, said outer surface being threaded adjacent to said first end, said pipe having a bend thereon to define a first portion and a second portion of said pipe, said first portion being oriented parallel to said second portion, said bend being positioned closer to said first end than said second end such that said first portion has a length being less than a length of said second portion, said second end threadably engaging said cap such that said pipe is in fluid communication with said reservoir, said pipe having an inner surface, said pipe having a fillet extending between said first end and said inner surface to define a seat extending around an entire circumference of said first end,
a sleeve having a top end and a bottom end, said top end threadably engaging said first end such that said sleeve is removably coupled to said pipe,
a screen being coupled to said sleeve, said screen completely covering said bottom end wherein said screen is configured to inhibit insects from entering said reservoir through said pipe, and
a ball being movably positioned within said sleeve, said ball being positionable in an open position and a closed position, said ball being spaced from said first end of said pipe when said ball is positioned in said open position wherein said ball is configured to allow air to pass through said first end, said ball frictionally engaging said seat when said ball is in said closed position, said ball forming a fluid impermeable seal with said seat when said ball is in said closed position, said ball being comprised of a buoyant material wherein said ball is configured to float on the liquid contaminant when the liquid contaminant enters said sleeve thereby facilitating said ball to be positioned in said closed position, said ball inhibiting said fluid from becoming contaminated wherein said ball is configured to maintain potability of said fluid.
